(19) United States
(12) Patent Application Publication
(10) Pub. No.: US 2008/0103235 A1
(43) Pub. Date: May 1, 2008

(54) Clear blends of bisphenol a polycarbonate and copolyesters

(76) Inventor: Wesley Raymond Hale, Kingsport, TN (US)

Correspondence Address: BRETT L. NELSON;EASTMAN CHEMICAL COMPANY, 100 NORTH EASTMAN ROAD, KINGSPORT, TN, 37660-5075, US

(21) Appl. No.: 11/591,238

(22) Filed: Nov. 1, 2006

(51) Int. Cl. C08K 5/49

(52) U.S. Cl. 524/115; 525/439

(57) ABSTRACT

A blend composition including a polycarbonate and a polyester. The wt % of the polycarbonate in the blend is wt % PC=30*Ln(IV)+89 or the inherent viscosity of the polyester in the blend is IV=0.0545^{(0.322 wt%PC)}. Moreover, the blend is clear and the total weight percent of the polycarbonate and the polyester is equal to 100 weight percent.

### FIELD OF THE INVENTION

The present invention relates to blends of polycarbonates and polyesters that are unexpectedly clear and miscible. More particularly, the present invention relates to clear miscible blends of the polycarbonate of bisphenol A and polyesters from aromatic dicarboxylic acids, 1,4-cyclohexanedimethanol, and ethylene glycol units, wherein the ethylene glycol to 1,4-cyclohexanedimethanol ratio is between 9:1 and 1:1.

### BACKGROUND OF THE INVENTION

The polycarbonate of 4,4′-isopropylidenediphenol (bisphenol A polycarbonate) is a well known engineering molding plastic. Bisphenol A polycarbonate is a clear high-performance plastic having good physical properties such as dimensional stability, high heat resistance, and good impact strength. Although bisphenol-A polycarbonate has many good physical properties, its relatively high melt viscosity leads to poor melt processability and the polycarbonate exhibits poor chemical resistance.

Aromatic carbonate polymers are a well known and available family of materials which enjoy a variety of applications in the field of plastics. These polymers can be prepared by a number of procedures. In one way, the polymer is produced by reacting a dihydric phenol, e.g., 2,2-bis(4-hydroxyphenyl)propane, with a carbonate precursor, e.g., phosgene, in the presence of an acid binding agent.

The subject invention relates to novel thermoplastic miscible blends of polycarbonate and polyester having high clarity. More particularly, the subject invention relates to thermoplastic compositions comprising an aromatic carbonate polymer and a polyester copolymer derived from a glycol portion comprising 1,4-cyclohexanedimethanol and ethylene glycol present in molar ratios of 1:9 to 1:1 respectively and an acid portion comprising at least one aromatic dicarboxylic acid selected from terephthalic acid, isophthalic acid and mixtures of the two.

Clear, miscible blends of any two polymers are rare. The term “miscible” refers to blends that are a mixture on a molecular level wherein intimate polymer-polymer interaction is achieved. Miscible blends are clear, not translucent or opaque. In addition, differential scanning calorimetry testing detects only a single glass transition temperature (Tg) for miscible blends composed of two or more components.

Blends display different physical properties based upon the nature of the polymers blended together as well as the concentration of each polymer in the blend. Attempts have been made to blend bisphenol-A polycarbonate with other polymers that have good chemical resistance, processability, and machinability. These attempts to improve melt processability, chemical resistance and other physical properties of bisphenol-A polycarbonate have been made by blending bisphenol A polycarbonate with polymers such as polystyrene, elastomers, polyesters, and polyesterimides. However, blends of bisphenol-A polycarbonate with other polymeric materials have usually resulted in immiscible blend compositions. Immiscible blend compositions are inadequate for many uses because they are not clear.

In general, aromatic polycarbonate resins can be molded or otherwise shaped into articles which possess certain desirable properties, including high impact strength in thin walled sections and good dimensional stability.

Polycarbonates are known to be mixable with various polyesters, including poly(alkylene terephthalates). More particularly, it is known that blends of polyesters with polycarbonates to provide thermoplastic compositions having improved properties over those based upon either of the single resins alone. Moreover, such blends are often more cost effective than polycarbonate alone.

There have been very few clear polycarbonate/polyester blends developed. U.S. Pat. No. 6,043,322 discloses clear blends of bisphenol-A polycarbonate and polyesters of terephthalic acid, isophthalic acid, ethylene glycol, and 2,2,4,4-tetramethyl-1,3-cyclobutanediol. U.S. Pat. Nos. 4,619,976 and 4,645,802 disclose clear blends based on bisphenol A polycarbonate with polyesters of poly(1,4-tetramethylene terephthalate), poly(1,4-cyclohexylenedimethylene terephthalate) and selected copolyesters and copoly(esterimides) of poly(1,4-cyclohexylenedimethylene terephthalate). U.S. Pat. No. 4,786,692 discloses clear blends of bisphenol-A polycarbonate and polyesters of terephthalic acid, isophthalic acid, ethylene glycol, and 1,4-cyclohexanedimethanol. U.S. Pat. Nos. 4,188,314 and 4,391,954 disclose clear blends of bisphenol A polycarbonate with poly(1,4-cyclohexylenedimethylene terephthalate-co-isophthalate). These polyester blends do have improved chemical resistance and melt processability, when compared to unblended bisphenol-A polycarbonate.

Poly(ethylene terephthalate) and poly(1,4-butylene terephthalate) have been widely used to form immiscible polyester-polycarbonate blends. For example, compositions of polycarbonate resins and polyester are disclosed by Nakamura et al. in U.S. Pat. No. 3,864,428.

Cohen et al., U.S. Pat. No. 4,257,937, describe multiphase thermoplastic molding compositions of poly(1,4-butylene terephthalate), optionally also containing poly(ethylene terephthalate), and a modifier composed of a combination of a polyacrylate resin and an aromatic polycarbonate. The compositions can also include fillers and/or reinforcements and flame retardant additives.

Fromuth et al., U.S. Pat. No. 4,264,487, disclose compositions based on aromatic polyesters such as polymeric resins of alkylene terephthalates, which contain synergistic amounts of acrylate-based core-shell polymer and aromatic polycarbonate. The compositions are described as having high impact strength and an increased heat deflection temperature, although they are not a homogeneous system.

Still other modified polyester compositions are described elsewhere in the patent literature. Dieck et al. in U.S. Pat. No. 4,220,735 indicate that a polyblend composed of poly(1,4-butylene terephthalate) resin and poly(ethylene terephthalate) resin can be modified for greater impact strength by including effective amounts of a selectively hydrogenated monoalkenyl arene-diene block copolymer, for example, polystyrene-polybutadiene-polystyrene, together with an aromatic polycarbonate resin, which is again an immiscible system.

Gergen et al. in U.S. Pat. No. 4,111,895 disclose multi-component multi-phase polymer blends comprised of polycarbonate, a selectively hydrogenated monoalkenyl arene-diene block copolymer and at least one dissimilar engineering thermoplastic, for example, thermoplastic polyesters. The components are admixed under conditions such that at least two of the polymers form continuous network phases which interlock with other polymer networks to produce a desirable balance of properties.

Bussink et al. in U.S. Pat. No. 4,267,096 teach that the use of a selectively hydrogenated elastomeric block copolymer together with an amorphous polyester improves the melt flow characteristics, resistance to brittle failure and resistance to environmental stress cracking of polycarbonate resin.

Japanese laid open patent application No. 044,373 describes thermoplastic molding compositions of polyester resin, e.g., poly(ethylene terephthalate), polycarbonate resin and minor amounts of a third resin obtained by polymerizing a shell comprising aromatic hydrocarbon and, optionally, methacrylate or similar monomer onto a rubbery acrylic core. The composition of these ingredients is said to have excellent moldability, mechanical and thermal properties.

A disadvantage associated with use of poly(alkylene terephthalate) is its relatively low notched impact strength, which this carries over into blends of the polyester with aromatic polycarbonates. It has been proposed that the notched impact strength of poly(alkylene terephthalates) can be improved upon by admixture with an impact modifier system composed of an aromatic polycarbonate and acrylate based polymer. Compositions of this type are disclosed in U.S. Pat. No. 4,257,937 (Cohen, et al.), U.S. Pat. No. 4,264,487 (Fromuth, et al.,) and the above-mentioned Japanese patent publication.

More recently, certain amorphous copolyesters, i.e., those having a low degree of crystallinity, have been developed. In U.S. Pat. No. 2,901,466 to Kibler et al., substantially amorphous polymeric linear polyesters and polyesteramides are described which are the condensation product of (1) either the cis or the trans isomer or a mixture of these isomers of 1,4-cyclohexanedimethanol alone or mixed with another bifunctional reactant, with (2) a bifunctional carboxy compound. The broad range of polymers defined therein include linear polyester polymers which have melting points as low as about 100° C. and the polyesters melting below about 200° C. are described as primarily useful for preparing molding compositions.

It has elsewhere more recently been disclosed that amorphous copolyesters having a low degree of crystallinity may be utilized in polycarbonate blends to provide improvements in impact strength and transparency, processability, solvent resistance and environmental stress cracking resistance.

Another thermoplastic resin blend incorporating a polycarbonate and an amorphous polyester is disclosed in U.S. Pat. No. 4,267,096. As described therein, useful compositions having improved processability and extrusion characteristics comprise a selectively hydrogenated linear, sequential or radial teleblock copolymer of a vinyl aromatic compound and, olefinic elastomer, an aromatic polycarbonate resin and an essentially amorphous polyester resin. The use of copolyesters of poly(alkylene terephthalate) type is preferred. More particularly, it is preferred to use copolyesters of from 99.5% to 94% by weight of poly(alkylene terephthalate) which contain, incorporated at random in the chain small amounts of from 0.5 to 5% by weight of dissimilar units in order to break down any tendency whatever for the “100%” pure polyester to crystallize. Alternatively, the use of a small amount of isophthalic acid instead of terephthalic 100% will also produce satisfactory amorphous polyesters. The use of the above-described amorphous poly(alkylene terephthalates) in the selectively hydrogenated block copolymer/polycarbonate blends is said to provide compositions which extrude smoothly and are easy to strand, each without excessive die swell. Articles made from these blends may be used at temperatures far above the glass transition temperature of the crystalline polyesters without loss in important properties.

In the past, articles molded from polycarbonates and poly(alkylene terephthalate)/polycarbonate resin blends had high heat distortion temperatures which required very high extrusion and molding temperatures in order to provide sufficient melt flow to the thermoplastic material to completely fill the interstices within molds. At these high molding and extrusion temperatures, degradation of the polymeric material frequently occurs which is often evidenced by discoloration of the material. The degradation of the material also contributes to a loss in impact strength, which is undesirable because high impact strength is one of the more functionally important attributes for shaped thermoplastic articles. The compositions of the present invention exhibit lower heat distortion temperatures, thereby permitting the compositions to be extruded and molded at lower processing temperature with significant reduction in degradation of the materials. Other important physical and mechanical properties of articles shaped from the instant compositions, such as tensile, flexural, and impact strengths are fully retained or improved upon with respect to the heat distortion temperature compositions of the prior art.

U.S. Pat. No. 4,786,692 discloses clear blends of bisphenol-A polycarbonate and copolyesters of terephthalic acid, isophthalic acid, ethylene glycol, and 1,4-cyclohexanedimethanol. The copolyesters for use in the subject invention generally will have an internal viscosity of at least about 0.4 dl./gm as measured in 60/40 phenol/tetrachloroethane or other similar solvent at about 25° C. and will have a heat distortion temperature of from about 60° C. to 70° C. Also disclosed is a preferred copolyester for use as in the subject invention is a copolyester as described above wherein the glycol portion has a predominance of ethylene glycol over 1,4-cyclohexanedimethanol (known as PETG), for example greater than 50/50 and especially preferably is about 70 molar ethylene glycol to 30 molar 1,4-cyclohexanedimethanol and the acid portion is terephthalic acid. It is disclosed that when this preferred copolyester is blended with bisphenol-A polycarbonate over broad ranges of the components, compatible two-phase blends are formed which exhibit two glass transition temperatures, an immiscible system.

U.S. Pat. No. 4,506,442 discloses a PC/polyester blend and an uncatalyzed process for preparing the blend by melt reactions between PC and polyesters for a long period of time (mixing time of up to 60 minutes). U.S. Pat. No. 5,055,531 discloses PC/polyester blends by reactive extrusion using catalysts, specifically metal based catalysts, in an amount of about 0.0005 to about 0.5 percent by weight, wherein a second extrusion step is needed to quench the catalyst used in the reaction. U.S. Pat. No. 6,281,299 discloses a process for manufacturing transparent polyester/polycarbonate compositions, wherein the polyester is fed into the reactor after bisphenol A is polymerized to a polycarbonate.

PCT WO2004020523 discloses transparent polycarbonate/polyester compositions with excellent balance of improved physical properties, and a single-stage melt extrusion process for making such compositions wherein an acidic stabilizing additive is added down-stream from the polycarbonate/polyester melt reaction location. According to this disclosure, the prepared transparent polycarbonate/polyester resin compositions and articles made from them have low temperature impact resistance, improved chemical resistance compared to polycarbonate, and good melt processability. According to this disclosure, such molding compositions may be prepared by a one-step reactive extrusion process for the manufacture of transparent polycarbonate/polyester blends, wherein the down-stream feeding of a catalyst quencher eliminates the need of a second pass through. According to this disclosure, which requires a minimal amount of catalyst, surprisingly produces transparent polycarbonate/polyester blends of desired and improved properties, including hydrolytic stability and melt viscosity stability. Disclosed suitable copolymeric polyester resins include, e.g., polyesteramide copolymers, cyclohexanedimethanol-terephthalic acid-isophthalic acid copolymers and cyclohexanedimethanol-terephthalic acid-ethylene glycol (“PETG”) copolymers.

In another disclosed embodiment of PCT WO2004020523, the polyester resin has an intrinsic viscosity of from about 0.4 to about 2.0 dl/g as measured in a 60:40 phenol/tetrachloroethane mixture at 25-30° C. The disclosed invention uses in the range of about 50 to 2000 ppm of the ester-interchange catalyst. In one disclosure the amount of catalyst used is in the range of about 50 to about 1000 ppm. The disclosed preferred amount of catalyst employed is in the range of about 50 ppm to about 300 ppm. Also disclosed are stabilizing additives such as catalyst quenchers which are used to stop the polymerization reaction between the polymers, if not, an accelerated interpolymerization and degradation of the polymers result, resulting in a blend of little value. Thus, it is obvious from this art, that miscible blends of PETG with polycarbonate can only be obtained through transesterification reactions, otherwise the blend will be immiscible and hazy.

It has now been discovered, contrary to the above disclosed art, that miscible blends are attainable, without the need for reactive extrusion, of bisphenol-A polycarbonate and copolyesters of terephthalic acid, isophthalic acid, ethylene glycol, and 1,4-cyclohexanedimethanol wherein the glycol portion has a predominance of ethylene glycol over 1,4-cyclohexanedimethanol. The thermoplastic compositions of this invention form a single phase system as evidenced by the fact that they exhibit either one glass transition temperatures and are transparent. These blends comprise bisphenol-A polycarbonate and polyesters of terephthalic acid, isophthalic acid, ethylene glycol, and 1,4-cyclohexanedimethanol wherein the ethylene glycol to 1,4-cyclohexanedimethanol ratio is 9:1 to 1:1 respectively wherein the inherent viscosity of the polyester is below a critical level and the polycarbonate to polyester weight ratio in the blend falls within a specified range. Discovering blends within this compositional range is unexpected in light of the prior art.

### BRIEF SUMMARY OF THE INVENTION

In one embodiment, the blend composition according to the present invention comprises:

(A) from 1 to 99 percent by weight of a polycarbonate comprising a diol component comprising from 90 to 100 mol percent 4,4′-isopropylidenediphenol units and from 0 to 10 mol percent modifying diol units having 2 to 16 carbons, wherein the total mol percent of diol units is equal to 100 mol percent; and

### (B) about 1 to 99 percent by weight of a polyester comprising

(a) a dicarboxylic acid component comprising from 80 to 100 mol percent dicarboxylic acid units selected from the group consisting of terephthalic acid units, isophthalic acid units, and mixtures thereof; and from 0 to 20 mol percent modifying dicarboxylic acid units having about 2 to 20 carbons, wherein the total mol percent of dicarboxylic acid units is equal to 100 mol percent; and
(b) a glycol component comprising from 10 to 50 mol percent 1,4-cyclohexanedimethanol units, from 50 to 90 mol percent ethylene glycol units, amd from 0 to 10 mol percent modifying glycol units having from 3 to 16 carbons, wherein the total mol percent of glycol units is equal to 100 mol percent;
wherein the total units of said polyester is equal to 200 mol percent;
wherein the wt % of component A in the blend is governed by the relationship wt % PC=30*Ln(IV)+89 or the IV of component B in the blend is governed by the relationship IV=0.0545 exp(0.0322*wt % PC); wherein said blend is clear and the total weight percent of said polycarbonate (A) and polyester (B) is equal to 100 weight percent. PC=polycarbonate; Ln=natural log; IV=inherent viscosity.

In another embodiment, the blend composition according to the present invention comprises:

(A) from 1 to 99 percent by weight of a polycarbonate comprising a diol component comprising from 90 to 100 mol percent 4,4′-isopropylidenediphenol units and from 0 to 10 mol percent modifying diol units having 2 to 16 carbons, wherein the total mol percent of diol units is equal to 100 mol percent; and

### (B) about 1 to 99 percent by weight of a polyester comprising

(a) a dicarboxylic acid component comprising from 80 to 100 mol percent dicarboxylic acid units selected from the group consisting of terephthalic acid units, isophthalic acid units, and mixtures thereof; and from 0 to 20 mol percent modifying dicarboxylic acid units having about 2 to 20 carbons, wherein the total mol percent of dicarboxylic acid units is equal to 100 mol percent; and
(b) a glycol component comprising from 25 to 35 mol percent 1,4-cyclohexanedimethanol units, from 65 to 75 mol percent ethylene glycol units, amd from 0 to 10 mol percent modifying glycol units having from 3 to 16 carbons, wherein the total mol percent of glycol units is equal to 100 mol percent;
wherein the total units of said polyester is equal to 200 mol percent;
wherein the wt % of component A in the blend is governed by the relationship wt % PC=30*Ln(IV)+89 or the IV of component B in the blend is governed by the relationship IV=0.0545 exp(0.0322*wt % PC); wherein said blend is clear and the total weight percent of said polycarbonate (A) and polyester (B) is equal to 100 weight percent.

In yet another embodiment, the blend composition according to the present invention comprises:

(A) from 1 to 99 percent by weight of a polycarbonate comprising a diol component comprising from 90 to 100 mol percent 4,4′-isopropylidenediphenol units and from 0 to 10 mol percent modifying diol units having 2 to 16 carbons, wherein the total mol percent of diol units is equal to 100 mol percent; and

### (B) about 1 to 99 percent by weight of a polyester comprising

(a) a dicarboxylic acid component comprising from 80 to 100 mol percent dicarboxylic acid units selected from the group consisting of terephthalic acid units, isophthalic acid units, and mixtures thereof; and from 0 to 20 mol percent modifying dicarboxylic acid units having about 2 to 20 carbons, wherein the total mol percent of dicarboxylic acid units is equal to 100 mol percent; and
(b) a glycol component comprising from 29 to 33 mol percent 1,4-cyclohexanedimethanol units, from 67 to 71 mol percent ethylene glycol units, amd from 0 to 10 mol percent modifying glycol units having from 3 to 16 carbons, wherein the total mol percent of glycol units is equal to 100 mol percent;
wherein the total units of said polyester is equal to 200 mol percent;
wherein the wt % of component A in the blend is governed by the relationship wt % PC=30*Ln(IV)+89 or the IV of component B in the blend is governed by the relationship IV=0.0545 exp(0.0322*wt % PC); wherein said blend is clear and the total weight percent of said polycarbonate (A) and polyester (B) is equal to 100 weight percent.

The invention also covers a method of making a clear article from the blend composition of the invention comprising the steps of:
(a) blending polycarbonate (A) and polyester (B);
(b) before, during or after the blending, melting polycarbonate (A) and polyester (B) to form after the blending and melting, a melt blend;
(c) then cooling the melt blend to form a clear blend composition

### DETAILED DESCRIPTION

The present invention may be understood more readily by reference to the following detailed description of preferred embodiments of the invention and the Examples included therein.

Before the present compositions of matter are disclosed and described, it is to be understood that this invention is not limited to specific synthetic methods or to particular formulations, as such may, of course, vary. It is also to be understood that the terminology used herein is for the purpose of describing particular embodiments only and is not intended to be limiting.

In this specification, the singular forms “a”, “an” and “the” include plural referents unless the context clearly dictates otherwise.

The applicants were surprised to discover clear blends of bisphenol-A polycarbonate and particular polyesters from aromatic dicarboxylic acids, 1,4-cyclohexanedimethanol, and ethylene glycol units. This discovery was particularly surprising since the teachings of a polycarbonate/polyester blend having a glycol component in the polyester with an ethylene glycol to 1,4-cyclohexanedimethanol ratio of less than 1:1 respectively are immiscible or require reactive extrusion. Further, there are no teachings suggesting that such a blend may be clear.

The term “polycarbonate” is herein defined as the condensation product of a carbonate source and a diol source, having a carbonate component containing 100 mol percent carbonate units and a diol component containing 100 mol percent diol units, for a total of 200 mol percent monomeric units. The term “diol” as used herein, includes both aliphatic and aromatic compounds having two hydroxyl groups, while the term “glycol” refers to aliphatic and aromatic/aliphatic compounds having two hydroxyl groups.

The polycarbonate portion of the blend of the present invention is based upon the polycarbonate of 4,4′-isopropylidenediphenol, commonly known as bisphenol A polycarbonate, shown below as compound I. The linear or branched polycarbonates that may be utilized in the present invention are derived from bisphenol A and may be prepared according to procedures well known in the art, e.g. the procedures described in U.S. Pat. Nos. 3,030,335 and 3,317,466. Examples of suitable bisphenol A polycarbonates include the materials marketed under the tradenames LEXAN, available from the General Electric Company, and MAKROLON, available from Beyer, Inc.

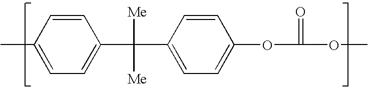

The polycarbonate portion of the present blend preferably has a diol component containing about 90 to 100 mole percent bisphenol A units, and 0 to about 10 mole percent can be substituted with units of other modifying aliphatic or aromatic diols, besides bisphenol A, having from 2 to 16 carbons. The polycarbonate can contain branching agents, such as tetraphenolic compounds, tri-(4-hydroxyphenyl) ethane, pentaerythritol triacrylate and others discussed in U.S. Pat. Nos. 6,160,082; 6,022,941; 5,262,51; 4,474,999; and 4,286,083. Other suitable branching agents are mentioned herein below. It is preferable to have at least 95 mole percent of diol units in the polycarbonate being bisphenol A. Suitable examples of modifying aromatic diols include the aromatic diols disclosed in U.S. Pat. Nos. 3,030,335 and 3,317,466.

The inherent viscosity of the polycarbonate portion of the blends according to the present invention is preferably at least about 0.3 dL/g, more preferably at least 0.5 dL/g, determined at 25° C. in 60/40 wt/wt phenol/tetrachloroethane.

The melt flow of the polycarbonate portion of the blends according to the present invention is preferably between 1 and 20, and more preferably between 2 and 18, as measured according to ASTM D1238 at a temperature of 300° C. and using a weight of 1.2 kg.

The polycarbonate portion of the present blend can be prepared in the melt, in solution, or by interfacial polymerization techniques well known in the art. Suitable methods include the steps of reacting a carbonate source with a diol at a temperature of about 0° C. to 315° C. at a pressure of about 0.1 to 760 mm Hg for a time sufficient to form a polycarbonate. Commercially available polycarbonates that can be used in the present invention, are normally made by reacting an aromatic diol with a carbonate source such as phosgene, dibutyl carbonate, or diphenyl carbonate, to incorporate 100 mol percent of carbonate units, along with 100 mol percent diol units into the polycarbonate. For examples of methods of producing polycarbonates, see U.S. Pat. Nos. 5,498,688; 5,494,992; and 5,489,665, which are incorporated by reference in their entirety.

Processes for preparing polycarbonates are known in the art. The linear or branched polycarbonate that can be used in the invention disclosed herein is not limited to or bound by the polycarbonate type or its production method. Generally, a dihydric phenol, such as bisphenol A, is reacted with phosgene with the use of optional mono-functional compounds as chain terminators and tri-functional or higher functional compounds as branching or crosslinking agents. Reactive acyl halides are also condensation polymerizable and have been used in polycarbonates as terminating compounds (mono-functional), comonomers (di-functional), or branching agents (tri-functional or higher).

One method of forming branched polycarbonates, disclosed, for example, in U.S. Pat. No. 4,001,884, involves the incorporation of an aromatic polycarboxylic acid or functional derivative thereof in a conventional polycarbonate-forming reaction mixture. The examples in the '884 patent demonstrate such incorporation in a reaction in which phosgene undergoes reaction with a bisphenol, under alkaline conditions typically involving a pH above 10. Experience has shown that a preferred aromatic polycarboxylic acid derivative is trimellitic acid trichloride. Also disclosed in the aforementioned patent is the employment of a monohydric phenol as a molecular weight regulator; it functions as a chain termination agent by reacting with chloroformate groups on the forming polycarbonate chain.

U.S. Pat. No. 4,367,186 disclose a process for producing cross-linked polycarbonates wherein a cross-linkable polycarbonate contains methacrylic acid chloride as a chain terminator. A mixture of bisphenol A, aqueous sodium hydroxide, and methylene chloride is prepared. To this is added a solution of methacrylic acid chloride in methylene chloride. Then, phosgene is added, and an additional amount of aqueous sodium hydroxide is added to keep the pH between 13 and 14. Finally, the triethylamine coupling catalyst is added.

EP 273 144 discloses a branched poly(ester)carbonate which is end capped with a reactive structure of the formula —C(O)—CH═CH—R, wherein R is hydrogen or C1-3 alkyl. This polycarbonate is prepared in a conventional manner using a branching agent, such as trimellityl trichloride and an acryloyl chloride to provide the reactive end groups. According to the examples, the process is carried out by mixing water, methylene chloride, triethylamine, bisphenol A, and optionally para-t-butyl phenol as a chain terminating agent. The pH is maintained at 9 to 10 by addition of aqueous sodium hydroxide. A mixture of terephthaloyl dichloride, isophthaloyl dichloride, methylene chloride, and optionally acryloyl chloride, and trimellityl trichloride is added dropwise. Phosgene is then introduced slowly into the reaction mixture.

Randomly branched polycarbonates and methods of preparing them are known from U.S. Pat. No. 4,001,184. At least 20 weight percent of a stoichiometric quantity of a carbonate precursor, such as an acyl halide or a haloformate, is reacted with a mixture of a dihydric phenol and at least 0.05 mole percent of a polyfunctional aromatic compound in a medium of water and a solvent for the polycarbonate. The medium contains at least 1.2 mole percent of a polymerization catalyst. Sufficient alkali metal hydroxide is added to the reaction medium to maintain a pH range of 3 to 6, and then sufficient alkali metal hydroxide is added to raise the pH to at least 9 but less than 12 while reacting the remaining carbonate precursor.

U.S. Pat. No. 6,225,436 discloses a process for preparing polycarbonates which allows the condensation reaction incorporation of an acyl halide compound into the polycarbonate in a manner which is suitable in batch processes and in continuous processes. Such acyl halide compounds can be mono-, di-, tri- or higher-functional and are preferably for branching or terminating the polymer molecules or providing other functional moieties at terminal or pendant locations in the polymer molecule.

U.S. Pat. No. 5,142,088 discloses the preparation of branched polycarbonates, and more particularly to novel intermediates useful in the preparation and a method for conversion of the intermediates via chloroformate oligomers to the branched polycarbonates. One method for making branched polycarbonates with high melt strength is a variation of the melt-polycondensation process where the diphenyl carbonate and Bisphenol A are polymerized together with polyfunctional alcohols or phenols as branching agents.

DE 19727709 discloses a process to make branched polycarbonate in the melt-polymerization process using aliphatic alcohols. It is known that alkali metal compounds and alkaline earth compounds, when used as catalysts added to the monomer stage of the melt process, will not only generate the desired polycarbonate compound, but also other products after a rearrangement reaction known as the “Fries” rearrangement. This is discussed in U.S. Pat. No. 6,323,304. The presence of the Fries rearrangement products in a certain range can increase the melt strength of the polycarbonate resin to make it suitable for bottle and sheet applications. This method of making a polycarbonate resin with a high melt strength has the advantage of having lower raw material costs compared with the method of making a branched polycarbonate by adding “branching agents.” In general, these catalysts are less expensive and much lower amounts are required compared to the branching agents.

JP 09059371 discloses a method for producing an aromatic polycarbonate in the presence of a polycondensation catalyst, without the use of a branching agent, which results in a polycarbonate possessing a branched structure in a specific proportion. In particular, JP 09059371 discloses the fusion-polycondensation reaction of a specific type of aromatic dihydroxy compound and diester carbonate in the presence of an alkali metal compound and/or alkaline earth metal compound and/or a nitrogen-containing basic compound to produce a polycarbonate having an intrinsic viscosity of at least 0.2. The polycarbonate is then subject to further reaction in a special self-cleaning style horizontal-type biaxial reactor having a specified range of the ratio L/D of 2 to 30 (where L is the length of the horizontal rotating axle and D is the rotational diameter of the stirring fan unit). JP 09059371 teaches the addition of the catalysts directly to the aromatic dihydroxy compound and diester carbonate monomers.

U.S. Pat. No. 6,504,002 discloses a method for production of a branched polycarbonate composition, having increased melt strength, by late addition of branch-inducing catalysts to the polycarbonate oligomer in a melt polycondensation process, the resulting branched polycarbonate composition, and various applications of the branched polycarbonate composition. The use of polyhydric phenols having three or more hydroxy groups per molecule, for example, 1,1,1-tris-(4-hydroxyphenyl)ethane (TH PE), 1,3,5-tris-(4-hydroxyphenyl)benzene, 1,4-bis-[di-(4-hydroxyphenyl)phenylmethyl]benzene, and the like, as branching agents for high melt strength blow-moldable polycarbonate 30 resins prepared interfacially has been described in U.S. Pat. Nos. Re. 27,682 and 3,799,953.

Other methods known to prepare branched polycarbonates through heterogeneous interfacial polymerization methods include the use of cyanuric chloride as a branching agent (U.S. Pat. No. 3,541,059), branched dihydric phenols as branching agents (U.S. Pat. No. 4,469,861), and 3,3-bis-(4-hydroxyaryl)-oxindoles as branching agents (U.S. Pat. No. 4,185,009). Additionally, aromatic polycarbonates end-capped with branched alkyl acyl halides and/or acids and said to have improved properties are described in U.S. Pat. No. 4,431,793.

Trimellitic triacid chloride has also been used as a branching agent in the interfacial preparation of branched polycarbonate. U.S. Pat. No. 5,191,038 discloses branched polycarbonate compositions having improved melt strength and a method of preparing them from aromatic cyclic polycarbonate oligomers in a melt equilibration process.

The term “polyester”, as used herein, refers to any unit-type of polyester falling within the scope of the polyester portion of the present blend, including but not limited to homopolyesters, copolyesters, and terpolyesters. The polyester portion of the blend of the present invention comprises a dicarboxylic acid component comprising from 80 to 100 mol percent dicarboxylic acid units selected from the group consisting of terephthalic acid units, isophthalic acid units, and mixtures thereof; and from 0 to 20 mol percent modifying dicarboxylic acid units having about 2 to 20 carbons, wherein the total mol percent of dicarboxylic acid units is equal to 100 mol percent; and a glycol component comprising from 10 to 50 mol percent 1,4-cyclohexanedimethanol units, from 50 to 90 mol percent ethylene glycol units, and from 0 to 10 mol percent modifying glycol units having from 3 to 16 carbons, wherein the total mol percent of glycol units is equal to 100 mol percent; wherein the total units of said polyester is equal to 200 mol percent. In a preferred embodiment the polyester comprises and a glycol component comprising from 10 to 50 mol percent 1,4-cyclohexanedimethanol units, from 50 to 90 mol percent ethylene glycol units, and from 0 to 10 mol percent modifying glycol units having from 3 to 16 carbons, wherein the total mol percent of glycol units is equal to 100 mol percent; wherein the total units of said polyester is equal to 200 mol percent Terephthalic acid and isophthalic acid have been found to be the preferred primary dicarboxylic acids for providing a polyester that when blended with bisphenol A polycarbonate is clear. A higher concentration of terephthalic acid in the polyester than isophthalic acid is preferred because terephthalic acid produces a polyester that provides greater impact strength to the blend. Therefore, it is preferred that the dicarboxylic acid component of the polyester portion be 50 to 100 mol percent terephthalic acid and 0 to 50 mol percent isophthalic acid, more preferably 70 to 100 mol percent terephthalic acid and 0 to 30 mol percent isophthalic acid, with about 100 mol percent terephthalic acid being most preferred.

In addition to terephthalic acid and isophthalic acid, the dicarboxylic acid component of the polyester can be substituted with up to 20 mol percent, but preferably less than 10 mol percent of other modifying dicarboxylic acids having 2 to 20 carbon atoms. Suitable examples of modifying aromatic dicarboxylic acids include 4,4′-biphenyldicarboxylic acid, 1,4-, 1,5-, 2,6-, 2,7-naphthalenedicarboxylic acid, 4,4′-oxybenzoic, trans-4,4′-stilbenedicarboxylic acid, or mixtures thereof. Suitable examples of modifying aliphatic dicarboxylic acids are those containing 2 to 12 carbon atoms, such as oxalic, malonic, succinic, glutaric, adipic, pimelic, suberic, azelaic, and sebacic acids, or mixtures thereof.

The dicarboxylic acid component of the polyester portion of the present blend can be derived from dicarboxylic acids, their corresponding esters, or mixtures thereof. Examples of esters of the dicarboxylic acids useful in the present invention include the dimethyl, dipropyl, diisopropyl, dibutyl, and diphenyl esters, and the like.

The glycol component of the polyester portion of the present blend is formed from 10 to 50 mol percent 1,4-cyclohexanedimethanol units, from 50 to 90 mol percent ethylene glycol units, and from 0 to 10 mol percent modifying glycol units having from 3 to 16 carbons. Preferably about from 25 to 35 mol percent 1,4-cyclohexanedimethanol units and from 65 to 75 mol percent ethylene glycol units. Even more preferably about from 29 to 33 mol percent 1,4-cyclohexanedimethanol units and from 67 to 71 mol percent ethylene glycol units.

The glycol component of the polyester portion of the present blend contains 0 to about 10 mol percent, but preferably less than 5 mol percent of other modifying glycol units containing 3 to 16 carbon atoms. Examples of suitable modifying glycols include 1,2-propanediol, 1,3-propanediol, 1,4butanediol, 1,5-pentanediol, 1,6-hexanediol, trans- or cis-1,4-cyclohexanedimethanol,p-xylene glycol, neopentyl glycol and mixtures thereof. The glycol component can also be modified with 0 to about 10 mol percent polyethylene glycol or polytetramethylene glycol to enhance elastomeric behavior. The polyester component may contain up to about 5 mole percent, preferably up to 1.5 mol %, based on the acid or glycol component, of the residue of a polyfunctional branching agent derived from a compound having at least three carboxyl and/or hydroxy groups to form a branched polyester. Examples of such compounds include trimellitic acid or anhydride, trimesic acid, trimethylolethane, trimethylolpropane, a trimer acid, etc.

The inherent viscosity of the polyester portion of the blends according to the present invention is preferably at least 0.3 dL/g, more preferably at least 0.45 dL/g, and more preferably at least 0.55 determined at 25° C. in 60/40 wt/wt phenol/tetrachloroethane.

The blends of the present invention are about 1 to 99 weight percent polyester portion and about 1 to 99 weight percent polycarbonate portion, with the total weight percent of the polycarbonate portion and polyester portion preferably being equal to 100 weight percent; wherein the wt % of component A in the blend is governed by the relationship wt % PC=30*Ln(IV)+89 or the IV of component B in the blend is governed by the relationship IV=0.0545 exp(0.0322*wt % PC); wherein said blend is clear and the total weight percent of said polycarbonate (A) and polyester (B) is equal to 100 weight percent.

Greater concentrations of the polycarbonate of the blend nearer 99 weight percent produce blends having greater impact strength, heat resistance, and dimensional stability, while blends nearer 99 weight percent polyester have better chemical resistance and melt processability. The most useful blends will be those clear blends having a combination of physical properties best suited for a particular end use, as will be determined on a case by case basis.

For the polycarbonates of the invention, suitable carbonate sources for the carbonate units are preferably phosgene; dialkyl carbonate, such as preferably dibutyl carbonate; or diaryl carbonate, such as preferably diphenyl carbonate.

The blend compositions of the present invention are clear. The term “clear” is defined herein as an absence of cloudiness, haziness, and muddiness, when inspected visually. The blends of the present invention also exhibit a single glass transition temperature (Tg), as determined by differential scanning calorimetry (DSC).

The chemical resistance and melt processability of the blends of the present invention are good. It is generally known that blending with a polyester improves the chemical resistance and melt processability of polycarbonates. See U.S. Pat. Nos. 4,188,314 and 4,267,096.

The polycarbonate portion of the present blend can be prepared in the melt, in solution, or by interfacial polymerization techniques well known in the art. Suitable methods include the steps of reacting a carbonate source with a diol at a temperature of about 0° C. to 315° C. at a pressure of about 0.1 to 760 mm Hg for a time sufficient to form a polycarbonate. Commercially available polycarbonates that are typically used in the present invention, are normally made by reacting an aromatic diol with a carbonate source such as phosgene, dibutyl carbonate or diphenyl carbonate, to incorporate 100 mol percent of carbonate units, along with 100 mol percent diol units into the polycarbonate. For examples of methods of producing polycarbonates, see U.S. Pat. Nos. 5,498,688, 5,494,992, and 5,489,665 which are incorporated by this reference in their entireties for all their teachings.

The polyester portion of the present invention can be made by processes known from the literature such as, for example, by processes in homogeneous solution, by transesterification processes in the melt and by two phase interfacial processes. Suitable methods include the steps of reacting one or more dicarboxylic acids with one or more glycols at a temperature of about 100° C. to 315° C. at a pressure of about 0.1 to 760 mm Hg for a time sufficient to form a polyester. See U.S. Pat. No. 3,772,405 for methods of producing polyesters. These polyesters exhibit enhanced properties without a significant increase in viscosity at low shear rates. The amorphous copolyesters also have improved resistance to attack by lipid solutions and are readily molded and extruded to form medial devices such as connectors, tubes, etc. which are useful for transport of lipids and other medical solutions. The compositions can also be shaped into house ware objects such as food containers and bowls which are often exposed to chemical attack and require the improve chemical resistance accompanied with the presence of the polyester component of the blend. The compositions of the present invention can be formed into useful articles by any of the known methods for shaping thermoplastics, including extrusion, thermoforming, blow molding, compression molding, and injection molding. In one embodiment, the compositions are shaped into house ware objects such as food containers and bowls

The polyester/polycarbonate blends of the present invention can be made by methods which include the steps of blending the polycarbonate and polyester portions of the present invention at a temperature of about 25° C. to 350° C. for a time sufficient to form a clear blend composition. Suitable conventional blending techniques include the melt method and the solution-prepared method. Other suitable blending techniques include dry blending and/or extrusion.

The melt blending method includes blending the polymers at a temperature sufficient to melt the polycarbonate and polyester portions, and thereafter cooling the blend to a temperature sufficient to produce a clear blend. The term “melt” as used herein includes, but is not limited to, merely softening the polymers. For melt mixing methods generally known in the polymers art, see Mixing and Compounding of Polymers (I. Manas-Zloczower & Z. Tadmor eds., Carl HanserVerlag publisher, N.Y. 1994).

The solution-prepared method includes dissolving the appropriate weight/weight ratio of polyester and polycarbonate in a suitable organic solvent such as methylene chloride or a 70/30 mixture of methylene chloride and hexafluoroisopropanol, mixing the solution, and separating the blend composition from solution by precipitation of the blend or by evaporation of the solvent. Solution-prepared blending methods are generally known in the polymers art.

The melt blending method is the preferred method for producing the blend compositions of the present invention. The melt method is more economical and safer than the solution-prepared method which requires the use of volatile solvents. The melt method is also much more effective in providing clear blends. Any of the clear blends of the present invention that can be prepared by solution blending can also be prepared by the melt method. However, some of the blends of the present invention can be prepared by the melt method, but not by the solution method. Any blending process which provides clear blends of the present invention is suitable. One of ordinary skill in the art will be able to determine appropriate blending methods for producing the clear blends of the present invention.

Although not required, other additives typically present in polyesters may be used if desired so long as they do not hinder the performance of the polyesters used to prepare the film. Such additives may include, but are not limited to, antioxidants, ultraviolet light and heat stabilizers, metal deactivators, colorants, pigments, impact modifiers, nucleating agents, branching agents, flame retardants, and the like. Typically, such additives constitute not more than about 20 weight percent, preferably not more than 10 weight percent, of the total weight of the blend

In addition to the polycarbonate and polyester portions disclosed above, the blend of the present invention can include at least one other modifying polymer. Suitable modifying polymers are those which form miscible blends with the polycarbonate and polyester portions disclosed above. Possible modifying polymers include other polycarbonates, other polyesters, polyamides, polystyrenes, polyurethanes, polyarylates, liquid crystalline polymers, vinyl polymers, and the like, or a mixture thereof. Suitable modifying polymers may be determined by one of ordinary skill in the polymers art by performing traditional miscibility tests with possible modifying polymers.

A polymer may be determined to be a suitable modifying polymer of the blend of the present invention if a clear blend is formed by: 1) blending the modifying polymer with a pre-existing blend containing the polycarbonate and polyester portions, or 2) blending the modifying polymer with the polycarbonate portion prior to the introduction of the polyester portion, or 3) blending the modifying polymer with the polyester portion prior to the introduction of the polycarbonate portion, or 4) mixing the modifying polymer, polycarbonate portion and polyester portion all together prior to blending.

The clear blends of the present invention can still be further modified by the incorporation of blend modifiers to produce performance blends, which may not necessarily be clear. For example, polyamides such as nylon 6,6 from DuPont, poly(ether-imides) such as ULTEM poly(ether-imide) from General Electric, polyphenylene oxides such as poly(2,6-dimethylphenylene oxide) or poly(phenylene oxide)/polystyrene blends such as the NORYL resins from General Electric, polyesters, polyphenylene sulfides, polyphenylene sulfide/sulfones, poly(ester-carbonates) such as LEXAN 3250 poly(ester-carbonate) (General Electric), polycarbonates other than LEXAN polycarbonate from General Electric, polyarylates such as ARDEL D100 polyarylate (Amoco), polysulfones, polysulfone ethers, poly(ether-ketones) or aromatic dihydroxy compounds can be used as blend modifiers to modify properties or to reduce flammability. The aromatic dihydroxy compounds used to prepare these polymers are disclosed in U.S. Pat. No. 3,030,335 and U.S. Pat. No. 3,317,466.

The blends of the present invention can also contain antioxidants, conventional flame retardants such as phosphorus or halogen compounds, or fillers such as talc or mica, or reinforcing agents such as glass fiber, KEVLAR, or carbon fiber. Additives such as pigments, dyes, stabilizers, plasticizers, etc. can also be used in the polyesters, polycarbonates, and blends of the present invention to further modify the properties of the inventive blends. Additives used to neutralize catalysts such as phosphorus compounds can also be used.

The blends of the present invention are useful in producing clear articles of manufacture having improved chemical resistance and melt processability while retaining excellent mechanical properties. These blends are especially useful for making molded articles, fibers, films, and sheeting.

The following examples are intended to illustrate the present invention but are not intended to limit the reasonable scope thereof.

### EXAMPLES

The glass transition temperatures (Tg's) of the pellets were determined using a TA Instruments 2920 differential scanning calorimeter (DSC) at a scan rate of 20.degree. C./min. The polymer blends of the present invention are characterized by a novel combination of properties including a clarity or haze value of about 0.5 to 3.0 as determined by a HunterLab UltraScan Sphere 8000 Colorimeter manufactured by Hunter Associates Laboratory, Inc., Reston, Va. using Hunter's Universal Software (version 3.8). % Haze=100*DiffuseTransmission/TotalTransmission. Calibration and operation of the instrument was done according to the HunterLab User Manual. To reproduce the results on any colorimeter, run the instrument according to its instructions. Diffuse transmission is obtained by placing a light trap on the other side of the integrating sphere from where the sample port is, thus eliminating the straight-thru light path. Only light scattered by greater than 2.5 degrees is measured. Total transmission includes measurement of light passing straight-through the sample and also off-axis light scattered to the sensor by the sample. The sample is placed at the exit port of the sphere so that off-axis light from the full sphere interior is available for scattering. (Regular transmission is the name given to measurement of only the straight-through rays—the sample is placed immediately in front of the sensor, which is approximately 20 cm away from the sphere exit port—this keeps off-axis light from impinging on the sample.) Heat Deflection Temperature is determined by ASTM D648, Notched Izod Impact Strength is performed according to ASTM D256. Flexural properties are determined according to ASTM D790. The tensile properties of the blend determined according to ASTM D638 at 23° C. The inherent viscosity of the polyesters was determined in 60/40 (wt/wt) phenol/tetrachloroethane at a concentration of 0.5 g/100 mL at 25° C. The glycol content of the polyester portion of these blends was determined by proton nuclear magnetic resonance spectroscopy (NMR). Clarity was determined visually and with haze measurements. The miscibility of the blends was determined by differential scanning calorimetry and by observation of the clarity of pressed films and molded objects.

The preparation of polycarbonates is well known in the art. See U.S. Pat. Nos. 3,030,335 and 3,317,466. The bisphenol A polycarbonate used was LEXAN, available from the General Electric Company or MAKROLON 2608, available from Beyer, Inc. For all examples MAKROLON 2608 was used.

Copolyesters are copolymers of similar compositions were prepared from terephthalic acid and similar percentages of the glycol 1,4-cyclohexanedimethanol (CHDM) and ethylene glycol (EG) in the ratio of 3:7 respectively. Synthesis was carried out in an 18 gallon stainless-steel batch reactor, with intermeshing spiral agitators. Copolyesters shown in Table 1 below were prepared from DMT (dimethylterephthalate) with EG (ethylene glycol), and CHDM (1,4 cyclohexanedimethanol). For the synthesis of this material, the appropriate amounts of metal catalysts were added to provide 32 parts per million (ppm) titanium, 46 ppm manganese, 65 ppm cobalt, and 23 ppm P in the final copolyester. To an 18 gallon stainless-steel batch reactor, with intermeshing spiral agitators, was added appropriate amounts of DMT, EG, and CHDM. Appropriate amounts of a butanol solution containing the titanium catalyst and an EG solution containing manganese catalyst were added. The reactor which was under a 10 SCFH nitrogen purge was heated to 200° C. and held for 1.5 hours with agitation. The reactor was then heated to 220° C. and held for 1 hour with agitation after which the cobalt and phosphorous catalysts were added. Methanol was removed from the reaction mixture during these hold times as a byproduct. The temperature was then increased to 270° C. When the reaction mixture reached 240° C., vacuum was applied at a rate of 13 mm/min. When the pressure had dropped to 5-mm and the melt temperature was 270° C., the vacuum was held with agitation for a total of X minutes to attain the desired IV (See Table 1 below for values of X). Afterwards the polymer was let down to a nitrogen purge. The polymer was extruded and pelletized. Also used are two commercially available copolyesters, PETG 5011 and PM 20110.

The resultant compositions and inherent viscosity of these copolyesters are shown in Table 1.

TABLE 1

| | NMR ANALYSIS | | | | |
|---|---|---|---|---|---|
| | mol % | mol % | mol % | | X minutes @ 270° C., |
| Material | CHDM | EG | DEG | IV | 5-mm vac. |
| A | 30 | 69 | 1 | 0.215 | 0 |
| B | 30 | 69 | 1 | 0.315 | 5 |
| C | 31 | 68 | 1 | 0.449 | 15 |
| D | 31 | 68 | 1 | 0.470 | Commercial Product - |
| | | | | | PM20110 |
| E | 31 | 68 | 1 | 0.590 | Commercial Product - |
| | | | | | PETG 5011 |
| F | 31 | 68 | 1 | 0.596 | 45 |

The copolyesters listed in Table 1 were then blended with bisphenol A polycarbonate and a phosphorous additive. The phosphorous concentrate was prepared by first hydrolyzing Weston 619 buy melting it and soaking it in water, allowing the excess water to evaporate. A powdered version Eastar 5445 is then added to the now hydrolyzed molten Weston 619 and mixed until it a homogeneous solution is formed. This material is then extruded in a twin-screw extruder at 280° C. and pelletized. The final phosphorous content in the pellets is 5 wt %. First, all polyester components were dried overnight at 70 deg C. and all polycarbonate was dried overnight at 120 deg. C. Blends were processed in a Werner Pfleider 30 mm twin-screw extruder equipped with moderate mixing screws at 270 deg C. The copolyesters in Table 1 were blended with MAKROLON 300-10 bisphenol A polycarbonate from Beyer and 3 wt % of the phosphorous additive in a Werner Pfleider 30 mm twin-screw extruder equipped with moderate mixing screws at 270° C. and pelletized. The blends were dried overnight at 80° C. and then injection molded into ⅛ inch thick 4″ square plaques, flex bars, or dogbones at 270° C. on a Toyo 90 injection molding machine. The resulting haze values are shown in Table 2 below. Selected DSC properties are shown with haze values in Table 3. Selected Mechanical Properties are shown in Table 4.

TABLE 2

| | | | | Poly- | |
|---|---|---|---|---|---|
| Ex- | Copolyester | Copolyester | Copolyester | carbonate | |
| ample | component B | wt % | IV | wt % | % Haze |
| 1 | A | 77 | 0.215 | 20 | 92.01 |
| 2 | A | 57 | 0.215 | 40 | 26.95 |
| 3 | A | 48.5 | 0.215 | 48.5 | 5.99 |
| 4 | A | 42 | 0.215 | 55 | 0.93 |
| 5 | A | 20 | 0.215 | 77 | 0.35 |
| 6 | B | 47 | 0.315 | 50 | 41.91 |
| 7 | B | 42 | 0.315 | 55 | 24.81 |
| 8 | B | 40 | 0.315 | 57 | 21.23 |
| 9 | B | 37 | 0.315 | 60 | 7.98 |
| 10 | B | 32 | 0.315 | 65 | 2.63 |
| 11 | B | 30 | 0.315 | 67 | 0.56 |
| 12 | B | 27 | 0.315 | 70 | 1.03 |
| 13 | B | 20 | 0.315 | 77 | 0.37 |
| 14 | C | 30 | 0.449 | 67 | 16.29 |
| 15 | C | 20 | 0.449 | 77 | 0.57 |
| 16 | C | 10 | 0.449 | 87 | 0.34 |
| 17 | D | 77 | 0.47 | 20 | 94.21 |
| 18 | D | 48.5 | 0.47 | 48.5 | 65.4 |
| 19 | D | 48.5 | 0.47 | 48.5 | 72.35 |
| 20 | D | 49 | 0.47 | 49 | 68 |
| 21 | D | 40 | 0.47 | 57 | 52.1 |
| 22 | D | 37 | 0.47 | 60 | 44.87 |
| 23 | D | 32 | 0.47 | 65 | 30.57 |
| 24 | D | 30 | 0.47 | 67 | 20.51 |
| 25 | D | 27 | 0.47 | 70 | 4.92 |
| 26 | D | 22 | 0.47 | 75 | 2.19 |
| 27 | D | 20 | 0.47 | 77 | 0.82 |
| 28 | D | 20 | 0.47 | 77 | 1.04 |
| 29 | D | 17 | 0.47 | 80 | 0.50 |
| 30 | E | 32 | 0.59 | 65 | 43.17 |
| 31 | E | 27 | 0.59 | 70 | 21.11 |
| 32 | E | 22 | 0.59 | 75 | 6.56 |
| 33 | F | 20 | 0.596 | 77 | 2.63 |
| 34 | E | 17 | 0.59 | 80 | 0.78 |
| 35 | E | 12 | 0.59 | 85 | 0.64 |
| 36 | F | 10 | 0.596 | 87 | 0.39 |
| 37 | F | 5 | 0.596 | 92 | 0.58 |
| 38 | E | 7 | 0.59 | 90 | 0.57 |

All blends contain 3 wt % of the Phosphorous additive concentrate

TABLE 3

| | Copolyester | Copolyester | Copolyester | Polycarbonate | | Second heat | |
|---|---|---|---|---|---|---|---|
| Example | component B | wt % | IV | wt % | % Haze | Tg1 | Tg2 |
| 3 | A | 48.5 | 0.215 | 48.5 | 5.99 | 71 | 107 |
| 5 | A | 20 | 0.215 | 77 | 0.35 | 115 | |
| 8 | B | 40 | 0.315 | 57 | 21.23 | 77 | 121 |
| 11 | B | 30 | 0.315 | 67 | 0.56 | 77 | 121 |
| 13 | B | 20 | 0.315 | 77 | 0.37 | 124 | |
| 14 | C | 30 | 0.449 | 67 | 16.29 | 80 | 129 |
| 15 | C | 20 | 0.449 | 77 | 0.57 | 131 | |
| 16 | C | 10 | 0.449 | 87 | 0.34 | 134 | |
| 18 | D | 48.5 | 0.47 | 48.5 | 65.4 | 82 | 128 |
| 21 | D | 40 | 0.47 | 57 | 52.1 | 81 | 128 |
| 24 | D | 30 | 0.47 | 67 | 20.51 | 81 | 131 |
| 27 | D | 20 | 0.47 | 77 | 0.82 | 132 | |
| 33 | F | 20 | 0.596 | 77 | 2.63 | 132 | |
| 36 | F | 10 | 0.596 | 87 | 0.39 | 137 | |
| 37 | F | 5 | 0.596 | 92 | 0.58 | 140 | |

All blends contain 3 wt % of the Phosphorous additive concentrate

TABLE 4

| | | | | | FlexProp | | |
|---|---|---|---|---|---|---|---|
| | | | | | 23° C., ASTM D 790. | | |
| | Copolyester | Copolyester | Copolyester | Polycarbonate | FlxMdls | YldStrn | YldStrs |
| Example | component B | wt % | IV | wt % | [psi] | [%] | [psi] |
| 1 | A | 77 | 0.215 | 20 | | | |
| 3 | A | 48.5 | 0.215 | 48.5 | 376855 | 5.5 | 14291 |
| 5 | A | 20 | 0.215 | 77 | 373591 | 6.8 | 14637 |
| 8 | B | 40 | 0.315 | 57 | 349804 | 6.2 | 13531 |
| 11 | B | 30 | 0.315 | 67 | 363225 | 6.6 | 14240 |
| 13 | B | 20 | 0.315 | 77 | 366116 | 7.1 | 14320 |
| 14 | C | 30 | 0.449 | 67 | 350251 | 6.9 | 13911 |
| 15 | C | 20 | 0.449 | 77 | 361014 | 7.3 | 14346 |
| 16 | C | 10 | 0.449 | 87 | 355931 | 7.4 | 14161 |
| 18 | D | 48.5 | 0.47 | 48.5 | 346546 | 5.8 | 12735 |
| 21 | D | 40 | 0.47 | 57 | 348535 | 6.2 | 13161 |
| 24 | D | 30 | 0.47 | 67 | 361729 | 6.6 | 13796 |
| 27 | D | 20 | 0.47 | 77 | 365507 | 7.1 | 14371 |
| 33 | F | 20 | 0.596 | 77 | 348443 | 7.0 | 13750 |
| 36 | F | 10 | 0.596 | 87 | 355215 | 7.5 | 14010 |
| 37 | F | 5 | 0.596 | 92 | 335914 | 7.4 | 13354 |

| | | | Izod | | | | | |
|---|---|---|---|---|---|---|---|---|
| | | | 23° C., | Tnsl-D638 | | | | |
| | | | Notch | 23° C., Large-I, NoExt | | | | |
| | HDT | | EnergyAvg | | | Enrgy/Vol | | |
| | 264 psi | 66 psi | AllModes | BrkStrn | BrkStrs | @Brk | YldStrn | YldStrs |
| Example | T [° C.] | T [° C.] | [ft-lb/in] | [%] | [psi] | [lb/in\hat{ }2] | [%] | [psi] |
| 1 | | | | | | | | |
| 3 | 73 | 87 | 0.3 | 3 | 6511 | 86 | 2.7 | 6511 |
| 5 | 99 | 112 | 1.3 | 100 | 8882 | 6825 | 6.4 | 9644 |
| 8 | 88 | 104 | 1.2 | 45 | 6566 | 2683 | 6.0 | 9120 |
| 11 | 94 | 106 | 1.2 | 66 | 7346 | 4199 | 6.1 | 9392 |
| 13 | 101 | 114 | 1.6 | 85 | 7955 | 5515 | 6.2 | 9360 |
| 14 | 96 | 115 | 1.7 | 91 | 7975 | 5858 | 6.4 | 9146 |
| 15 | 104 | 116 | 1.8 | 77 | 8098 | 5150 | 6.5 | 9436 |
| 16 | 112 | 126 | 17.1 | 109 | 9476 | 7726 | 6.6 | 9265 |
| 18 | 80 | 106 | 1.4 | 97 | 6705 | 5388 | 5.5 | 8417 |
| 21 | 92 | 113 | 1.7 | 79 | 6883 | 4559 | 6.1 | 8656 |
| 24 | 101 | 116 | 1.8 | 109 | 8375 | 6923 | 6.2 | 8950 |
| 27 | 103 | 117 | 2.0 | 76 | 7786 | 4979 | 6.6 | 9453 |
| 33 | 106 | 120 | 2.2 | 105 | 8829 | 7115 | 6.3 | 9029 |
| 36 | 114 | 126 | 11.2 | 84 | 8142 | 5468 | 6.8 | 9049 |
| 37 | 116 | 129 | 16.9 | 42 | 7196 | 2650 | 7.0 | 9023 |

We claim:

1. A blend composition comprising:
(A) from 1 to 99 percent by weight of a polycarbonate (PC) comprising a diol component comprising from 90 to 100 mol percent 4,4′-isopropylidenediphenol units and from 0 to 10 mol percent modifying diol units having 2 to 16 carbons, wherein the total mol percent of diol units is equal to 100 mol percent; and
(B) about 1 to 99 percent by weight of a polyester comprising
(a) a dicarboxylic acid component comprising from 80 to 100 mol percent dicarboxylic acid units selected from the group consisting of terephthalic acid units, isophthalic acid units, and mixtures thereof; and from 0 to 20 mol percent modifying dicarboxylic acid units having about 2 to 20 carbons, wherein the total mol percent of dicarboxylic acid units is equal to 100 mol percent; and
(b) a glycol component comprising from 10 to 50 mol percent 1,4-cyclohexanedimethanol units, from 50 to 90 mol percent ethylene glycol units, amd from 0 to 10 mol percent modifying glycol units having from 3 to 16 carbons, wherein the total mol percent of glycol units is equal to 100 mol percent; wherein the total units of said polyester is equal to 200 mol percent;
wherein a wt % of component A in the blend is wt % PC=30*Ln(IV)+89 or an inherent viscosity (IV) of component B in the blend is IV=0.0545^{(0.0322*wt%PC)}; wherein said blend is clear and the total weight percent of said polycarbonate (A) and polyester (B) is equal to 100 weight percent.

2. A blend composition comprising:
(A) from 1 to 99 percent by weight of a polycarbonate (PC) comprising a diol component comprising from 90 to 100 mol percent 4,4′-isopropylidenediphenol units and from 0 to 10 mol percent modifying diol units having 2 to 16 carbons, wherein the total mol percent of diol units is equal to 100 mol percent; and
(B) about 1 to 99 percent by weight of a polyester comprising
(a) a dicarboxylic acid component comprising from 80 to 100 mol percent dicarboxylic acid units selected from the group consisting of terephthalic acid units, isophthalic acid units, and mixtures thereof; and from 0 to 20 mol percent modifying dicarboxylic acid units having about 2 to 20 carbons, wherein the total mol percent of dicarboxylic acid units is equal to 100 mol percent; and
(b) a glycol component comprising from 25 to 35 mol percent 1,4-cyclohexanedimethanol units, from 65 to 75 mol percent ethylene glycol units, amd from 0 to 10 mol percent modifying glycol units having from 3 to 16 carbons, wherein the total mol percent of glycol units is equal to 100 mol percent;
wherein the total units of said polyester is equal to 200 mol percent;
wherein a wt % of component A in the blend is wt % PC=30*Ln(IV)+89 or an inherent viscosity of component B in the blend is IV=0.0545^{(0.0322*wt%PC)}; wherein said blend is clear and the total weight percent of said polycarbonate (A) and polyester (B) is equal to 100 weight percent.

3. A blend composition comprising:
(A) from 1 to 99 percent by weight of a polycarbonate (PC) comprising a diol component comprising from 90 to 100 mol percent 4,4′-isopropylidenediphenol units and from 0 to 10 mol percent modifying diol units having 2 to 16 carbons, wherein the total mol percent of diol units is equal to 100 mol percent; and
(B) about 1 to 99 percent by weight of a polyester comprising
(a) a dicarboxylic acid component comprising from 80 to 100 mol percent dicarboxylic acid units selected from the group consisting of terephthalic acid units, isophthalic acid units, and mixtures thereof; and from 0 to 20 mol percent modifying dicarboxylic acid units having about 2 to 20 carbons, wherein the total mol percent of dicarboxylic acid units is equal to 100 mol percent; and
(b) a glycol component comprising from 29 to 33 mol percent 1,4-cyclohexanedimethanol units, from 67 to 71 mol percent ethylene glycol units, amd from 0 to 10 mol percent modifying glycol units having from 3 to 16 carbons, wherein the total mol percent of glycol units is equal to 100 mol percent; wherein the total units of said polyester is equal to 200 mol percent;
wherein a wt % of component A in the blend is wt % PC=30*Ln(IV)+89 or an inherent viscosity of component B in the blend is IV=0.0545^{(0.0322*wt%PC)}; wherein said blend is clear and the total weight percent of said polycarbonate (A) and polyester (B) is equal to 100 weight percent.

4. The composition of claim 3 wherein said polycarbonate (A) is present at from 70 to 99 weight percent, based on the weight of the blend composition, and said polyester (B) is present at from 1 to 30 weight percent, based on the weight of the blend composition; wherein the polyester has an inherent viscosity of about at least 0.58.

5. The composition of claim 3 wherein said polycarbonate (A) is present at from 70 to 99 weight percent, based on the weight of the blend composition, and said polyester (B) is present at from 1 to 30 weight percent, based on the weight of the blend composition; wherein the polyester has an inherent viscosity of about 0.59.

6. The composition of claim 3 wherein said polycarbonate (A) is present at from 70 to 99 weight percent, based on the weight of the blend composition, and said polyester (B) is present at from 1 to 30 weight percent, based on the weight of the blend composition; wherein the polyester has an inherent viscosity of about at least 0.45.

7. The composition of claim 3 wherein said polycarbonate (A) is present at from 70 to 99 weight percent, based on the weight of the blend composition, and said polyester (B) is present at from 1 to 30 weight percent, based on the weight of the blend composition; wherein the polyester has an inherent viscosity of about 0.47.

8. The composition of claim 1 wherein said dicarboxylic acid component of said polyester contains 100 mol percent terephthalic acid units.

9. The composition of claim 1 wherein said dicarboxylic acid component of said polyester comprises from 70 to 100 mol percent terephthalic acid and from 0 to 30 mol percent isophthalic acid.

10. The composition of claim 1 wherein said modifying dicarboxylic acid units of said polyester are selected from the group consisting of 4,4′-biphenyldicarboxylic acid; 1,4-, 1,5-, 2,6-, 2,7-naphthalenedicarboxylic acid; 4,4′-oxydibenzoic acid; trans-4,4′-stilbenedicarboxylic acid; oxalic acid; malonic acid; succinic acid; glutaric acid; adipic acid; pimelic acid; suberic acid; azelaic acid; sebacic acid; and mixtures thereof.

11. The composition of claim 1 wherein said modifying glycol units of said polyester are selected from the group consisting of 1,2-propanediol, 1,3-propanediol, 1,4-butanediol, 1,5-pentanediol, 1,6-hexanediol, trans-1,4-cyclohexanedimethanol, cis-1,4-cyclohexanedimethanol, p-xylene glycol, neopentyl glycol and mixtures thereof.

12. The composition of claim 1 wherein said blend composition has a single glass transition temperature.

13. The composition of claim 1 wherein said polycarbonate has an inherent viscosity of at least 0.3 dL/g at 25.degree.C. and said polyester has an inherent viscosity of at least 0.3 dL/g at 25.degree.C.

14. The composition of claim 3 wherein said polycarbonate comprises a branching agent.

15. The composition of claim 12 wherein said blend comprises a phosphorous containing stabilizer.

16. A clear article of manufacture made from the composition according to claim 1, selected from the group consisting of molded articles, fibers, films, and sheeting.

17. A clear article of manufacture made from the composition according to claim 1.

18. A method of using the blend of claim 1 to produce a clear article of manufacture comprising:
(a) blending polycarbonate (A) and polyester (B) of claim 1;
(b) before, during or after the blending, melting polycarbonate (A) and polyester (B) to form after the blending and melting, a melt blend;
(c) then cooling the melt blend to form a clear blend composition.
